(19) United States
(12) Patent Application Publication
(10) Pub. No.: US 2008/0276544 A1
(43) Pub. Date: Nov. 13, 2008

(54) Cemented Carbides

(75) Inventors: Kazuhiro Hirose, Itami-shi (JP); Eiji Yamamoto, Itami-shi (JP)

Correspondence Address: DITTHAVONG MORI & STEINER, P.C., 918 Prince St., Alexandria, VA, 22314, US

(73) Assignees: Sumitomo Electric Industries, Ltd., Osaka-shi (JP); Sumitomo Electric Hardmetal Corp., Itami-shi (JP)

(21) Appl. No.: 11/568,529

(22) PCT Filed: Oct. 5, 2005
(86) PCT No.: PCT/JP05/18473

§ 371 Date: Oct. 31, 2006

(30) Foreign Application Priority Data
Oct. 19, 2004 (JP) 2004-304944

(51) Int. Cl. C09K 3/14

(52) U.S. Cl. 51/307

(57) ABSTRACT

The present invention provides a cemented carbide with superior strength and toughness by refining the WC in the alloy uniformly and by restricting the growth of coarse WC efficiently. In this cemented carbide, WC with a mean particle diameter of no more than 0.3 microns serves as a hard phase and at least one type of iron group metal element at 5.5-15 percent by mass serves as a binder phase. In addition to this hard phase and binder phase, this cemented carbide contains 0.005-0.06 percent by mass of Ti, Cr at a weight ratio relative to the binder phase of at least 0.04 and no more than 0.2, with the remaining portion being formed from inevitable impurities. In particular, this cemented carbide does not contain Ta.

### CROSS-REFERENCE TO PRIOR APPLICATIONS

This application is a U.S. national phase application under 35 U.S.C. §371 of International Patent Application No. PCT/JP2005/018473, filed Oct. 5, 2005, and claims the benefit of Japanese Application No. 2004-304944, filed Oct. 19, 2004, both of which are incorporated by reference herein. The International Application was published in Japanese on Apr. 27, 2006 as International Publication No. WO 2006/043421 A1 under PCT Article 21(2).

### TECHNICAL FIELD

The present invention relates to a cemented carbide and a tool using the same. More specifically, the present invention relates to a cemented carbide that can provide superior strength when used in cutting tools and wear resistant members.

### BACKGROUND ART

Conventionally, a cemented carbide containing WC with a mean particle diameter of no more than 1 micron as a hard phase, i.e., so-called fine grained cemented carbide, is known as a material with superior strength and wear resistance (e.g., see Japanese Laid-Open Patent Publication Number Sho 61-195951). The standard method for forming fine grain WC for a cemented carbide is to use fine raw WC powders. However, even with cemented carbides made using fine raw WC powders, tools formed from these cemented carbides may exhibit sudden breakage or fracture depending on how they are used. One known reason for this is that by increasing hardness by significantly reducing the particle size of the WC serving as the hard phase leads to a trade-off that reduces fracture toughness. Also, another factor is the presence, seen when cross-section structure is observed by a microscope, of coarse WC that has grown to at least 2 microns. This coarse WC tends to become the starting-point for destruction and significantly reduces alloy characteristics and cutting characteristics and wear resistance when used as tools. Since cemented carbide generally undergoes liquid phase sintering, the binder phase is in the liquid phase during sintering. The hard phase that has undergone solid solution diffusion in the liquid phase reprecipitates as coarse WC during the cooling step. This leads to grain growth known as Ostwald growth. This grain growth is especially difficult to restrict when ultra-fine grain raw powder, e.g., less than 1 micron, is used. This leads to ununiformity in the fine structure. Then, the addition to the alloy composition of a grain growth inhibitor such as V, Cr, or Ta that can inhibit grain growth in order to suppress WC grain growth has been investigated (see Japanese Laid-Open Patent Publication Number 2001-115229).

### SUMMARY OF THE INVENTION

The addition of V, Cr, or Ta can suppress WC grain growth and refine the mean particle diameter. However, complete suppressing of coarse grain growth is difficult only by adding these grain growth inhibitors. Thus, in addition to providing uniform refinement, it is necessary to reduce coarse grains, which can tend to become fracture source and fracturing.

Also, as the fineness of the WC in the cemented carbide increases, the hardness and strength tends to increase. Thus, one method for increasing hardness and strength would be to use finer WC in the cemented carbide. More specifically, finer raw WC powders can be used to provide a mean particle diameter of no more than 0.3 microns. However, when this type of ultra-fine raw powder is used, there is a greater tendency for the grain growth described above to take place, leading to coarse grains that will result in defects.

An object of the present invention is to provide a cemented carbide with superior strength and toughness with uniformly fine WC and minimal coarse WC. Another object of the present invention is to provide a machining tool that uses this cemented carbide.

In order to achieve the objects described above, the present inventors looked into refining the alloy structure by using a finer raw material powder. In cemented carbides with a fine-grain hard phase, it is believed that strength (e.g., transverse-rupture strength) generally increases for smaller WC particle diameters. However, if a fine raw material powder is used to try to obtain ultra-fine WC, e.g., no more than 1 micron, WC grain growth takes place, leading to decreased strength. In order to restrict WC grain growth, repeated study was made of the relationship between the binder phase amount and various grain growth inhibitors and combinations thereof. As a result, it was found that even with an element (specifically, Ta) that has been used conventionally as a WC growth inhibitor, grain growth can take place at the phase containing this element, leading to defects. Also, it was discovered that even with an element (specifically, Ti) that has not conventionally been used as a WC growth inhibitor, the addition of a predetermined amount can be extremely effective in limiting WC growth. It was additionally found that there was a correlation between this element and the element in the binder phase, and that WC growth suppression requires the presence of a predetermined amount of this element as well as a predetermined amount of the element in the binder phase. Furthermore, it was also found that it is preferable to control the amount of an element (specifically, Cr) that has conventionally been used as a grain growth inhibitor so that there is a predetermined relationship with the amount of the binder phase. Based on these observations, the present invention defines a mean particle diameter for WC. Also, Cr and Ti are included as elements to promote the refinement of the WC that will form the hard phase. The Ti content, the relationship between the amounts of Cr and the binder phase, and the binder phase content are also defined.

More specifically, the cemented carbide of the present invention includes: WC with a mean particle diameter of no more than 0.3 microns serving as a hard phase; at least one type of an iron group metal at 5.5-15 percent by mass serving as a binder phase; Ti at 0.005-0.06 percent by mass; Cr at a weight ratio relative to said binder phase of at least 0.04 and no more than 0.2; and inevitable impurities taking up a remainder. In particular, Ta content is less than 0.005 percent by mass. The present invention will be described in more detail.

The cemented carbide of the present invention is a sintered compact with WC as a hard phase and an iron group metal element, e.g., Co, Ni, or Fe, as a binder phase. In particular, the hard phase (WC) in the sintered compact has a mean particle diameter of no more than 0.3 microns. If the mean particle diameter of WC exceeds 0.3 microns, hardness (wear resistance) is decreased and strength (transverse-rupture strength) is decreased. It is preferable for the mean particle diameter to be no more than 0.1 microns. Since hardness and strength increase for smaller mean particle diameters of WC, no lower limit is set for the mean particle diameter but in terms of the production steps there are practical limits. The mean particle diameter for WC is observed under a microscope (e.g., using an SEM (scanning electron microscope) at 8000-10000× and is calculated using a Fullman equation (dm=4N_{L}/πN_{S}, where dm is the mean particle size, N_{L} is the number of hard phases (WC) present per unit length along a line on the microscope surface, and N_{S} is the number of hard phases present per unit area on the microscope surface). The measurement length is arbitrary and the final particle diameter is calculated per unit length (1 micron). It would also be possible to observe the surface of the cemented carbide using an SEM at a high magnification (e.g., 8000-10000×). The image would be captured by a computer and analyzed with an image analyzer. WC particle diameters (microns) present in a fixed area range (e.g., 20-30 mm²) are measured, and the average of these values can be adjusted as appropriate using the Fullman equation. Since the hard phase of the sintered compact of the present invention has an ultra-fine particle diameter, particle diameter measurements can be made even when the unit area is very small, e.g., 1 micron². In conventional structure control methods, refining the mean particle diameter of WC in the sintered compact to be no more than 0.3 microns was considered difficult. However, in the present invention as described below, the addition of a trace amount of Ti, the control of the amount of Cr, and the absence of Ta makes it possible to provide a mean particle diameter of no more than 0.3 microns. Also, it is preferable for the raw WC powders to have a small mean particle diameter to reduce the coarsening caused by grain growth.

The cemented carbide of the present invention includes at least one type of element selected from the iron group of metals serving as a binder phase. In particular, Co is preferable. It would be possible to use Co by itself as the binder phase or a portion thereof can be replaced with Ni. The binder phase content (the total content if the binder phase is formed from a plurality of elements) is at least 5.5 percent by mass and no more than 15 percent by mass. If the content is less than 5.5 percent by mass, the transverse-rupture strength will be reduced even if the Ti and Cr contents, described later, are appropriate. If the content exceeds 15 percent by mass, there will be too much binder phase, possibly leading to the W (tungsten) in the binder phase excessively forming a solid solution and resulting in reprecipitation. This makes it difficult to limit the formation of coarse hard phase (WC), reducing the advantage of limiting coarse hard phase. It is more preferable for the binder phase content to be at least 7.0 percent by mass and no more than 12.0 percent by mass.

The cemented carbide of the present invention includes Cr as a grain growth inhibitor to suppress WC grain growth in the alloy structure. In particular, the Cr content is set to a predetermined proportion relative to the weight (percent by mass) of the iron group metal element serving as the binder phase. More specifically, the weight ratio of Cr relative to the binder phase is at least 0.04 and no more than 0.2. A weight ratio of at least 0.04 is preferable because there is improved grain growth suppression due to a synergistic effect with the presence of the trace amount of Ti described later. However, if the weight ratio is greater than 0.2, the excess Cr can cause a brittle phase (e.g., a carbide of Cr) to precipitate in the microstructure, with this precipitation acting as a starting point for decreased strength. It is more preferable for the weight ratio of Cr to be at least 0.08 and no more than 0.14.

In addition to the Cr described above, the present invention includes a trace amount of Ti. More specifically, the present invention includes at least 0.005 percent by mass and no more than 0.06 percent by mass. Ti is considered to have limited grain growth suppressing properties, and Ti was almost never actively added in the conventional technology for the purpose of structure control. However, the investigations of the present inventors revealed that, when controlling ultra-fine WC, e.g., no more than 0.3 microns, a trace amount of Ti can provide significant contributions to the control of WC grain growth. At this point, the present inventors discovered that, in addition to simply including a trace amount of Ti, controlling the content of the iron group metal element serving as the binder phase as described above can improve transverse-rupture strength by suppressing grain growth, more specifically by setting the binder phase content to at least 5.5 percent by mass. When a trace amount of Ti is added as a component to the cemented carbide, the wettability of the element serving as the binder phase and the WC is reduced somewhat. As a result, it is believed that when liquid phase occurs, the solid solution diffusion of the WC into the binder phase is restricted so that the Ostwald growth of WC is restricted. Thus, the present invention defines binder phase content as well as Ti content. If the Ti content is less than 0.005 percent by mass, the content is reduced to the level of impurities, thus minimizing grain growth suppression. If the content exceeds 0.06 percent by mass, strength is reduced. It is more preferable for the Ti content to be at least 0.01 percent by mass and no more than 0.04 percent by mass. By adding a trace amount of Ti in addition to Cr in this manner in the present invention, WC can be refined uniformly while the formation of coarse particles, e.g., exceeding 2 microns, can be suppressed, thus providing superior transverse-rupture strength. The content of each of the components can be determined through, e.g., ICP (inductively coupled plasma spectroscopy) analysis.

In the cemented carbide of the present invention, Ta content is less than 0.005 percent by mass. The present invention does not include a significant amount of Ta. Thus, in the present invention, it is most preferable for there to be no Ta, i.e., for the Ta content to be 0. Taking into account inevitable inclusion, it is preferable for the content to be no more than 0.003 percent by mass, with 0.005 percent by mass being the upper limit. Ta has been conventionally known as a grain growth inhibitor and has been actively added. However, the results of investigations by the present inventors indicated that for controlling ultra-fine WC, e.g., no more than 0.3 microns, the addition of Ta is not preferable. More specifically, it was found that the hard phase could grow significantly when a double carbide phase ((W, Ta)C) containing Ta or a Ta carbide is formed during the liquid phase sintering. It was also found that, even with the addition of elements such as Ti and Cr, refining these precipitants containing Ta by limiting grain growth was difficult. For this reason, the present invention does not include Ta.

Furthermore, it is preferable to add a predetermined amount of V (vanadium) to more effectively suppress grain growth and provide stable refinement. More specifically, V is included so that the ratio (weight ratio) of the weight of V (percent by mass) relative to the weight (percent by mass) of the iron group metal element serving as the binder phase is at least 0.01 and no more than 0.1. If the weight ratio is less than 0.01, the stability of the fine grain structure is inadequate, making the advantages provided by the addition of V are inadequate. If the weight ratio is greater than 0.1, the wettability of the hard phase and the binder phase is degraded, tending to reduce fracture toughness. It is more preferable for the weight ratio to be at least 0.01 and no more than 0.06.

An example of a method for producing the cemented carbide of the present invention with ultra-fine grain WC, e.g., no more than 0.3 microns, is to prepare the raw material powder, mix and mill the raw material powder, press, sinter, and perform hot isostatic pressing (HIP). For the WC powders, it is preferable to use ultra-fine grain powder, more specifically no more than 0.5 microns, and especially no more than 0.2 microns. This type of ultra-fine grain WC powders can be obtained using the direct carbonization method in which tungsten oxide is directly carbonized to provide ultra-fine and uniform WC particles. Also, WC particles can be made smaller by mixing and milling the raw material powder. In addition to WC powders, a powder containing Cr, Ti, and V if needed is prepared to provide the iron group metal powder serving as the binder phase and to suppress grain growth. The Cr, Ti, and V can be added as metal elements, compounds, composite compounds, or solid solutions. Examples of compounds and composite compounds include compounds formed from at least one element selected from carbon, nitrogen, oxygen, and boron and Cr, Ti, or V. A commercially available powder can be used as well. These powders can be pre-mixed, with further mixing and milling being performed additionally. Alternatively, the powders can be prepared separately and mixed during the mixing and milling step. The Ti content can be controlled by measurement, but it can also be possible to, e.g., perform mixing with a ball mill with a Ti coating and control the mixing time. The materials that have been mixed and milled are pressed at a predetermined pressure, e.g., 500-2000 kg/cm² and sintered in a vacuum. It is preferable for the sintering temperature to be low so that WC grain growth can be limited. More specifically, a temperature of 1300-1350° C. is preferable. In the present invention, HIP is performed after sintering to improve hardness, transverse-rupture strength, and toughness. Specifically, the HIP conditions are a temperature similar to that of the sintering temperature (1300-1350° C.), with a pressure of 10-100 MPa, preferably approximately 100 MPa (1000 atm). By applying HIP treatment in this manner, a cemented carbide with superior characteristics as described above can be provided even with low-temperature sintering.

The cemented carbide of the present invention is suited for use as a base material for machining tools such as cutting tools or wear-resistant tools. Examples of cutting tools include: round tools such as drills, end mills, rotors, and reamers; round tools for printed circuit boards such as micro-drills; and turning tools such as tools used for turning aluminum, cast iron and steel, and indexable inserts used for finishing. The advantages of the present invention are useful in high-precision processing applications such as in electrical and electronic devices that require sharp edge. Examples of wear-resistant tools include slicing tools such as rotary knives and punching tools such as punching dies. In machining tools that use the cemented carbide of the present invention for the entire base material, the reduction of coarse WC over the entirety rather than a portion of the base material results in minimal fracture source, thus providing improved breakage resistance and fracturing resistance. Also, the uniform refinement of the WC over the entire base material provides improved strength and good processing performance.

Micro-drills are tools used for boring in printed circuit boards and the like. Micro-drills with very small diameters, e.g., a drill diameter of 0.1-0.3 mm, are becoming dominant. With very small diameters such as these, the alloy structure of the entire base material must be fine and uniform or else destruction and breakage will tend to occur with the coarse hard phase in the structure acting as fracture source. Thus, when the fine grained cemented carbide of the present invention is used as the base material of the micro-drill, the characteristics of the cemented carbide of the present invention are expected to provide superior cutting performance compared to the conventional technology. Also, since the cemented carbide of the present invention provides superior strength and toughness in addition to wear resistance, boring can be performed on materials such as stainless steel plates, which conventional micro-drills break against. Furthermore, when the cemented carbide of the present invention is used, ultra-fine drills, e.g., with a drill diameter of 0.05 mm (50 microns), can be produced.

With turning tools that use the cemented carbide of the present invention, it is expected that sudden breakage of the cutting edge and the like can be prevented, thus improving chipping resistance, while the improved hardness is expected to increase wear resistance, thus providing superior cutting performance.

The cemented carbide of the present invention described above contains Ti, which has conventionally almost never been used as a grain growth inhibitor, while Ta, which has been used as a grain growth inhibitor, is absent. In the cemented carbide of the present invention, the amount of binder phase, Cr, and Ti are determined so that grain growth of the hard phase is efficiently inhibited. The hard phase is uniformly refined and the number of coarse particles is reduced. As a result, in various machining tools that use the cemented carbide of the present invention, sudden destruction and fracturing resulting from the presence of coarse hard phase in the microstructure can be reduced while strength can be improved through the uniform refinement of the hard phase. Thus, both high strength and toughness can be provided. As a result, the cemented carbide of the present invention can be used for various machining fields such as rotation cutting, precision cutting, turning, and processing that requires wear resistance.

### DETAILED DESCRIPTION OF THE INVENTION

The embodiments of the present invention will be described.

### First Example

A raw WC powder with a mean particle diameter of 0.5 microns, a raw Co powder with a mean particle diameter of 1 micron, Cr, V, Ti, Ta compound powders having the compositions shown in Table 1, and a suitable amount of C (carbon) powder were prepared. These items were mixed according to the amounts (mass %=percent by mass) shown in Table 1 and then milled and mixed in a ball mill for 48 hours. After using a spray drier to dry and granulate, the mixture was pressed at a pressure of 1000 kg/cm². Then, the result was raised to a sintering temperature of 1350° C. in a vacuum and sintered for 1 hour at that sintering temperature. Then, HIP treatment was performed for 1 hour at 1320° C. and 100 MPa, resulting in cemented carbide test samples No. 1-27. For each test sample, a JIS sample piece with a 20 mm span, a sample for evaluating Vickers hardness Hv, a sample for studying structure, and a sample for measuring compositions were prepared.

In addition, the following test samples having the same composition as the Test Sample no. 6 were prepared: a sample with a different mean particle diameter for the WC (Test Sample No. 50); a sample with some of the Co replaced with Ni (Test Sample No. 51); a sample that used a pre-mixed powder (Test Sample No. 52); a sample on which HIP was not performed (Test Sample No. 53). In Test Sample No. 50, raw WC powders with a mean particle diameter of 1.0 microns, raw Co powder with a mean particle diameter of 1 micron, a Cr, Ti compound powder having the composition shown in Table 1, and an appropriate amount of C powder were prepared. These were mixed according to the amounts shown in Table 1 and then milled and mixed in a ball mill for 48 hours. Then, drying, granulating, and pressing were performed as described above, and the result was sintered at a sintering temperature of 1400° C. Test Sample No. 51 was prepared under the same conditions as those of Test Samples No. 1-27 except that raw Co powder and raw Ni powder having a mean particle diameter of 1 micron were used. Test Sample No. 52 was prepared under the same conditions as those of Test Samples No. 1-27 except that the powders for the composition shown in Table 1 were mixed beforehand. In Test Sample No. 52, the powders of the composition shown in Table 1 were prepared. These were mixed according to the amounts shown in Table 1 and then milled and mixed in a ball mill for 48 hours. Then, drying, granulating, and pressing were performed as described above, and the result was sintered at a sintering temperature of 1450° C.

TABLE 1

| Test | | | TiC | | | | | | |
|---|---|---|---|---|---|---|---|---|---|
| Sample | WC | Co | | Ti | Cr₃C₂ | | VC | | TaC |
| No. | mass % | mass % | mass % | mass % | mass % | Cr/Co | mass % | V/Co | mass % |
| 1 | 96.32 | 3 | 0.03 | 0.024 | 0.65 | 0.10 | — | — | — |
| 2 | 93.992 | 4.9 | 0.008 | 0.006 | 1.1 | 0.10 | — | — | — |
| 3 | 93.97 | 4.9 | 0.03 | 0.024 | 1.1 | 0.10 | — | — | — |
| 4 | 93.392 | 5.5 | 0.008 | 0.006 | 1.1 | 0.09 | — | — | — |
| 5 | 93.37 | 5.5 | 0.03 | 0.024 | 1.1 | 0.09 | — | — | — |
| 6 | 87.77 | 10 | 0.03 | 0.024 | 2.2 | 0.10 | — | — | — |
| 7 | 81.87 | 15 | 0.03 | 0.024 | 3.1 | 0.10 | — | — | — |
| 8 | 79.47 | 17 | 0.03 | 0.024 | 3.5 | 0.10 | — | — | — |
| 9 | 87.795 | 10 | 0.005 | 0.004 | 2.2 | 0.10 | — | — | — |
| 10 | 87.79 | 10 | 0.01 | 0.008 | 2.2 | 0.10 | — | — | — |
| 11 | 87.73 | 10 | 0.07 | 0.056 | 2.2 | 0.10 | — | — | — |
| 12 | 87.72 | 10 | 0.08 | 0.064 | 2.2 | 0.10 | — | — | — |
| 13 | 87.7 | 10 | 0.1 | 0.080 | 2.2 | 0.10 | — | — | — |
| 14 | 89.37 | 10 | 0.03 | 0.024 | 0.6 | 0.03 | — | — | — |
| 15 | 89.17 | 10 | 0.03 | 0.024 | 0.8 | 0.04 | — | — | — |
| 16 | 88.47 | 10 | 0.03 | 0.024 | 1.5 | 0.07 | — | — | — |
| 17 | 86.47 | 10 | 0.03 | 0.024 | 3.5 | 0.16 | — | — | — |
| 18 | 85.97 | 10 | 0.03 | 0.024 | 4 | 0.19 | — | — | — |
| 19 | 85.47 | 10 | 0.03 | 0.024 | 4.5 | 0.21 | — | — | — |
| 20 | 87.67 | 10 | 0.03 | 0.024 | 2.2 | 0.10 | — | — | 0.1 |
| 21 | 87.27 | 10 | 0.03 | 0.024 | 2.2 | 0.10 | — | — | 0.5 |
| 22 | 86.77 | 10 | 0.03 | 0.024 | 2.2 | 0.10 | — | — | 1.0 |
| 23 | 87.67 | 10 | 0.03 | 0.024 | 2.2 | 0.10 | 0.1 | 0.008 | — |
| 24 | 87.62 | 10 | 0.03 | 0.024 | 2.2 | 0.10 | 0.15 | 0.012 | — |
| 25 | 87.27 | 10 | 0.03 | 0.024 | 2.2 | 0.10 | 0.5 | 0.040 | — |
| 26 | 86.57 | 10 | 0.03 | 0.024 | 2.2 | 0.10 | 1.2 | 0.097 | — |
| 27 | 86.37 | 10 | 0.03 | 0.024 | 2.2 | 0.10 | 1.4 | 0.113 | — |
| 50 | 87.77 | 10 | 0.03 | 0.024 | 2.2 | 0.10 | — | — | — |
| 51 | 87.77 | Co + Ni 10 | 0.03 | 0.024 | 2.2 | 0.10 | — | — | — |
| 52 | 87.77 | 10 | 0.03 | 0.024 | 2.2 | 0.10 | — | — | — |
| 53 | 87.77 | 10 | 0.03 | 0.024 | 2.2 | 0.10 | — | — | — |

To determine the Cr, Ti, Ta, and V content of the obtained test samples, the composition measurement samples were used to perform ICP analysis. The weight ratio of Cr relative to the weight (percent by mass) of the binder phase (Co or Co+Ni), and the same weight proportion for V were determined. Table 1 shows Ti analysis values, the weight ratio of Cr relative to Co, and the weight proportion of V relative to Co. For test samples in which VC or TaC were not added (indicated by a hyphen in Table 1), no V or Ta was detected.

Using the structure observation samples, the mean particle diameter (microns) of the hard phase (WC) in the alloy was determined with the Fullman equation. Observations were made using an SEM (3000×) with the unit length and the unit area being 1 micron and 1 micron², respectively. Also, the Vickers hardness Hv evaluation samples were used to measure Vickers hardness Hv. Furthermore, the JIS test pieces were used to perform transverse-rupture strength tests and determine transverse-rupture strengths. In these tests, the transverse-rupture strength was measured for 10 pieces of each test sample, and the average transverse-rupture strength value (GPa) for the 10 pieces and the minimum value (GPa) for the 10 pieces were determined. In evaluating these transverse-rupture strength tests, there is greater variation in transverse-rupture strength when there is a greater difference between the average value and the minimum value, indicating that there is a coarse hard phase that can tend to form a fracture source and fracturing in the structure. The results are shown in Table 2.

TABLE 2

| | | Average | Minimum | |
|---|---|---|---|---|
| | | transverse- | transverse- | |
| | Particle | rupture | rupture | |
| Test Sample | diameter | strength | strength | Hardness |
| No. | (μm) | (GPa) | (GPa) | Hv |
| 1 | 0.08 | 2.7 | 2.3 | 20.1 |
| 2 | 0.15 | 3.0 | 2.7 | 19.3 |
| 3 | 0.17 | 3.8 | 3.4 | 19.7 |
| 4 | 0.14 | 4.4 | 4.2 | 19.5 |
| 5 | 0.13 | 4.3 | 4 | 19.6 |
| 6 | 0.20 | 4.8 | 4.3 | 18.5 |
| 7 | 0.28 | 5.2 | 4.6 | 15.2 |
| 8 | 0.42 | 3.9 | 3.6 | 13.4 |
| 9 | 0.35 | 3.8 | 3.5 | 17.6 |
| 10 | 0.26 | 4.5 | 4.3 | 18.1 |
| 11 | 0.20 | 4.7 | 4.6 | 18.7 |
| 12 | 0.31 | 3.6 | 3.1 | 18.9 |
| 13 | 0.38 | 3.3 | 2.9 | 19.1 |
| 14 | 0.37 | 4.2 | 3.4 | 18.1 |
| 15 | 0.26 | 4.4 | 4.3 | 18.6 |
| 16 | 0.22 | 4.6 | 4.3 | 18.8 |
| 17 | 0.12 | 4.6 | 4.4 | 19.1 |
| 18 | 0.09 | 4.6 | 4.5 | 19.5 |
| 19 | 0.10 | 4.2 | 3.2 | 19.7 |
| 20 | 0.35 | 3.5 | 3.0 | 17.9 |
| 21 | 0.42 | 3.3 | 2.8 | 17.2 |
| 22 | 0.48 | 3.2 | 2.8 | 16.4 |
| 23 | 0.14 | 4.9 | 4.8 | 19.8 |
| 24 | 0.12 | 5.0 | 4.8 | 20.3 |
| 25 | 0.10 | 5.3 | 5.0 | 20.4 |
| 26 | 0.09 | 4.7 | 4.5 | 19.8 |
| 27 | 0.10 | 4.5 | 4.4 | 20.0 |
| 50 | 0.58 | 3.3 | 2.8 | 17.3 |
| 51 | 0.20 | 4.4 | 4.0 | 17.9 |
| 52 | 0.19 | 4.9 | 4.7 | 18.6 |
| 53 | 0.39 | 4.5 | 3.9 | 18.0 |

As Table 2 shows, in the Test Samples No. 4-7, 10-11, 15-18, 23-27, 51, 52, in which predetermined amounts of iron group metals are used as the binder phase, trace amounts of Ti are contained, and predetermined amounts relative to the binder phase of Cr are contained, the mean particle diameter of WC was very small, at no more than 0.3 microns, and hardness was high. Also, it can be seen that in these samples, the average transverse-rupture strengths are high while transverse-rupture strength variations are small. In general, as the particle size decreases, the hardness tends to increase while transverse-rupture strength tends to decrease. However, it can be seen that Test Samples Nos. 4-7, 10, 11, 15-18, 23-27, 51, 52 provide both superior hardness and transverse-rupture strength. In particular, it can be seen that Test Samples Nos. 23-27, which contain predetermined amounts of V, provide superior transverse-rupture strength and superior hardness.

By comparing Test Samples Nos. 1-8, it can be seen that binder phase content affects strength. By comparing Test Sample No. 6 and Test Samples Nos. 9-13, it can be seen that Ti content affects WC grain growth inhibition. By comparing Test Sample No. 6 and Test Samples Nos. 14-19, it can be seen that Cr content affects transverse-rupture strength variation. Because Test Sample No. 14 and Test Sample No. 19 have a high degree of transverse-rupture strength variation, coarse hard phases that can be fracture source and fracturing were present. More specifically, it can be seen that Cr content contributes to WC grain growth inhibition. By comparing Test Sample No. 6 and Test Samples Nos. 20-23, it can be seen that the presence of Ta affects WC grain growth inhibition.

By comparing Test Sample No. 6 and Test Sample No. 50, it can be seen that using finer raw powder provides finer WC, resulting in a high-strength, high-hardness cemented carbide. By comparing Test Sample No. 6 and Test Sample No. 51, it can be seen that using Co by itself in the binder phase provides a cemented carbide with superior characteristics. By comparing Test Sample No. 6 and Test Sample No. 52, it can be seen that various powders can be used. By comparing Test Sample No. 6 and Test Sample No. 53, it can be seen that low-temperature sintering and HIP processing can provide a fine cemented carbide with superior characteristics.

### Second Example

Micro-drills with a diameter of 0.3 mm were prepared using raw powders according to the compositions for the Test Samples Nos. 1-27. As in the First Example, the powders were milled, mixed, dried, and granulated. Then, the results were pressed into rods with 3.5 mm diameter and sintered at 1350° C. HIP processing was performed at 1320° C. and outer grinding (fluting) was performed, resulting in the micro-drills.

Boring tests (through-holes) were performed using the prepared micro-drills, and the cuts were evaluated. The workpiece was formed by stacking two printed circuit boards (1.6 mm thickness each) made from 4-layer laminates of alternating glass and epoxy resin layers (FR-4 copper-clad laminate as defined by ANSI) to form a total thickness of 3.2 mm. The cuts were performed at a rotation speed of N=150,000 r.p.m., a feed of f=15 microns/rev., and no cutting oil (dry). Cuts were evaluated based on the number of bores made until breakage. The results are shown in Table 3.

TABLE 3

| Test Sample | |
|---|---|
| No. | Number of cuts |
| 1 | 5060 |
| 2 | 5380 |
| 3 | 5690 |
| 4 | 6050 |
| 5 | 6000 |
| 6 | 6230 |
| 7 | 6180 |
| 8 | 5360 |
| 9 | 5290 |
| 10 | 6110 |
| 11 | 6290 |
| 12 | 5380 |
| 13 | 5200 |
| 14 | 5440 |
| 15 | 6180 |
| 16 | 6310 |
| 17 | 6350 |
| 18 | 6400 |
| 19 | 5660 |
| 20 | 5420 |
| 21 | 5080 |
| 22 | 5110 |
| 23 | 6680 |
| 24 | 6760 |
| 25 | 6580 |
| 26 | 6490 |
| 27 | 6190 |

As Table 3 shows, with the micro-drills formed from the Test Samples No. 4-7, 10-11, 15-18, 23-27, 51, 52, in which predetermined amounts of iron group metals are used as the binder phase, trace amounts of Ti are contained, and predetermined amounts relative to the binder phase of Cr are contained, superior breakage resistance was provided, i.e., superior toughness was provided. The reason for these results may be that there was almost no coarse WC in these micro-drills. Based on this, it can be seen that cutting tools formed from the cemented carbide of the present invention can provide superior breakage resistance and improved tool life.

### Third Example

Indexable inserts for the TNGG160404R-UM were prepared using raw powders according to the compositions for the Test Samples Nos. 1-27 from the First Example. Cutting tests were performed and cuts were evaluated. For the workpiece, an aluminum material (ADC12) was used. The cuts were performed at a cutting rate of V=500 m/min, a feed of f=0.1 mm/rev., a cutting depth of d=1.0 mm, and the use of a cutting fluid (wet cutting). Cuts were evaluated based on flank face wear (VB wear) after 15 hours of cutting. As a result, it was confirmed that wear was low for inserts formed from the Test Samples No. 4-7, 10-11, 15-18, 23-27, 51, 52, in which predetermined amounts of iron group metals are used as the binder phase, trace amounts of Ti are contained, and predetermined amounts relative to the binder phase of Cr are contained. These results are due to the uniform refinement of the hard phase of these inserts. Based on this, it can be seen that cutting tools formed from the cemented carbide of the present invention provide superior wear resistance and improved tool life.

### Fourth Example

Punching dies were formed using raw powders according to the compositions for the Test Samples Nos. 1-27. Wear resistance tests were performed to evaluate wear resistance. In the tests, stainless steel plates having a thickness of 0.2 mm were stamped with a punch diameter of 1.0 mm. The wear on the die was evaluated after a predetermined number of punching operations. As a result, it was found that reduced wear and superior strength was provided with dies formed from the Test Samples No. 4-7, 10-11, 15-18, 23-27, 51, 52, in which predetermined amounts of iron group metals are used as the binder phase, trace amounts of Ti are contained, and predetermined amounts relative to the binder phase of Cr are contained.

The cemented carbide of the present invention is suited for various types of tool materials which require wear resistance, strength, and toughness. More specifically, the present invention is suited for use in wear-resistant tools and cutting tools such as round tools, round tools used for processing printed circuit boards, turning tools, slicing tools, and punching tools. In particular, the present invention is suited for tool materials used in microfabrication applications, e.g., microfabrication tools for electronics such as drills with very small diameters (micro-drills) used to bore holes in printed circuit boards and the like, and tools to process parts used in the production of micromachines. Also, the machining tools of the present invention are suited for use in cutting and wear-resistant processing.

1. A cemented carbide comprising:
WC with a mean particle diameter of less than or equal to 0.3 microns serving as a hard phase;
at least one type of an iron group metal at 5.5-15 percent by mass serving as a binder phase;
Ti at 0.005-0.06 percent by mass;
Cr at a weight ratio relative to said binder phase of at least 0.04 and less than or equal to 0.2;
Ta at less than 0.005 percent by mass; and
inevitable impurities making up a remainder.

2. A cemented carbide according to claim 1 wherein said binder phase consist of Co.

3. A cemented carbide according to claim 1 further comprising V at a weight ratio relative to said binder phase of at least 0.01 and less than or equal to 0.1.

4. A machining tool made from a cemented carbide according to claim 1, said machining tool being a round tool, a round tool used for processing printed circuit boards, a turning tool, a slicing tool, or a punching tool.

5. A machining tool made from a cemented carbide according to claim 3, said machining tool being a round tool, a round tool used for processing printed circuit boards, a turning tool, a slicing tool, or a punching tool.

6. A cemented carbide according to claim 2 further comprising V at a weight ratio relative to said binder phase of at least 0.01 and less than or equal to 0.1.
